(19) United States
(12) Patent Application Publication
(10) Pub. No.: US 2013/0157794 A1
(43) Pub. Date: Jun. 20, 2013

(54) CVT SPIDER LOCK

(71) Applicants: Oliver Stegelmann, Strathroy (CA); Barry James Jackson, Windsor (CA)

(72) Inventors: Oliver Stegelmann, Strathroy (CA); Barry James Jackson, Windsor (CA)

(73) Assignee: The Gates Corporation, Denver, CO (US)

(21) Appl. No.: 13/615,741

(22) Filed: Sep. 14, 2012

Related U.S. Application Data
(60) Provisional application No. 61/577,185, filed on Dec. 19, 2011.

(51) Int. Cl. F16H 9/12

(52) U.S. Cl. 474/8

(57) ABSTRACT

This disclosure generally includes description of a clutch for a continuous variable transmission (CVT), more particularly to the drive clutch of a CVT for immovably coupling a spider portion to a CVT shaft during reverse rotation or acceleration or deceleration of the CVT shaft.

### REFERENCE TO RELATED APPLICATIONS

This non-provisional application claims priority from U.S. provisional application Ser. No. 61/577,185 filed Dec. 19, 2011.

### BACKGROUND

This disclosure relates generally to a clutch for a continuous variable transmission (CVT) more particularly to the drive clutch of a CVT, and specifically to a system for not allowing the spider of a CVT to unthread in a primary drive CVT.

Split sheave, belt-driven, continuously variable transmissions (CVT's) are used in a variety of recreational type off-road vehicles such as snowmobiles, golf carts, all-terrain vehicles (ATV's), as well as automobiles, and motorcycles, and the like. CVT's, as their name implies, do not require shifting through a series of forward gears, but rather provide a continuously variable ratio that automatically adjusts as the vehicle speeds up or slows down, thus providing relatively easy operation for the rider.

A typical CVT transmission is made up of a split sheave primary drive clutch connected to the output of the vehicle engine (often the crankshaft) and split sheave secondary driven clutch connected (often through additional drive train linkages) to the vehicle axle. An endless, flexible, generally V-shaped drive belt is disposed about the clutches. Each of the clutches has a pair of complementary sheaves, one of the sheaves being movable with respect to the other. The effective gear ratio of the transmission is determined by the positions of the movable sheaves in each of the clutches. The primary drive clutch has its sheaves normally biased apart (e.g., by a coil spring), so that when the engine is at idle speeds, the drive belt does not effectively engage the sheaves, thereby conveying essentially no driving force to the secondary driven clutch. The secondary driven clutch has its sheaves normally biased together (e.g., by a compression spring, as described below, so that when the engine is at idle speeds the drive belt rides near the outer perimeter of the driven clutch sheaves.

The spacing of the sheaves in the primary drive clutch usually may be controlled by centrifugal flyweights. Centrifugal flyweights are typically connected to the clutch shaft so that they rotate centrifugally along with the engine shaft speed. As the engine shaft rotates faster (in response to increased engine speed) the flyweights also rotate faster and pivot further outwardly, urging the movable sheave more toward the stationary sheave. The more outwardly the flyweights pivot, the more the moveable sheave is moved toward the stationary sheave. This pinches the drive belt, causing the belt to begin rotating with the drive clutch, the belt in turn causing the driven clutch to begin to rotate. Further movement of the drive clutch's movable sheave toward the stationary sheave forces the belt to climb outwardly on the drive clutch sheaves, increasing the effective diameter of the drive belt path around the drive clutch. Thus, the spacing of the sheaves in the drive clutch changes based on engine speed. The drive clutch therefore can be said to be speed sensitive.

As the sheaves of the drive clutch pinch the drive belt and force the belt to climb outwardly on the drive clutch sheaves, the belt (being effectively unstretchable) is pulled inwardly between the sheaves of the driven clutch, decreasing the effective diameter of the drive belt path around the driven clutch. This movement of the belt outwardly and inwardly on the drive and driven clutches, respectively, smoothly changes the effective gear ratio of the transmission in variable increments.

Split-sheave, belt driven CVTs are typically mechanical devices, that is, the mechanical parameters are established when the CVT is assembled. Once the CVT drive is assembled, the gear ratio depends on these set mechanical parameters as well as clutch spacing and belt length/width. For example, the gear ratio depends on the distance between the drive clutch sheaves. The distance between the drive clutch sheaves is determined by the amount of force produced by the flyweights against the movable sheave. As the flyweights are eventually connected to the engine shaft through the clutch shaft, the amount of the flyweight force depends on the speed of rotation of the engine shaft.

For some vehicles to be moved in reverse, the drive shaft of the motor must rotate in the opposite direction as when the vehicle is moving forward. This may cause problems with portions of the CVT.

Also when travelling forward, engines and drivetrains may accelerate in either forward or reverse direction, therefore CVTs and CVT clutches and clutch shafts may accelerate in either direction. This may cause a spider portion of the clutch to tend to decouple from the clutch shaft.

Representative of the prior art is U.S. Pat. No. 5,562,555 which discloses a variable speed belt drive having adjustable mass and moment of inertia camweights for use primarily in conjunction with snowmobile, golf cart, all terrain vehicle and small automobile engines. In one version, the camweight includes a series of perforations or score lines surrounding a cross section of the camweight arm. The perforations define a volume that may be snapped or cut off of the arm with a suitable tool. Also, a series of bores are formed through the arm. In order to increase the mass of the arm, a molten metal or similar flowable material may be poured into one or more of the bores and allowed to cure. In another version of the invention, a reduced cross section arm serves as a base onto which shims are added or reoriented in order to achieve the desired mass and moment of inertia characteristics.

What is needed is a secure locking method and system for locking the spider to the clutch shaft. With a need, also, for simplicity and serviceability.

### SUMMARY

The present disclosure is directed to systems and methods which provide generally secure attachment of a spider to the clutch shaft where the clutch shaft is driven or accelerated and/or decelerated bidirectionally. The systems and methods disclosed herein may inhibit the spider from uncoupling from the shaft.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The accompanying drawings, which are incorporated in and form part of the specification in which like numerals designate like parts, illustrate embodiments of the present disclosure and together with the description, serve to explain the principles of the disclosure. In the drawings:

FIG. 1 is a plan view of a CVT system according to an embodiment of the disclosure.

FIG. 2 is a plan view of a CVT drive clutch system according to an embodiment.

FIG. 3 is a plan view a spider portion coupled to a shaft according to an embodiment.

FIG. 4 is a plan view of a spider and locking device generally coupled to a shaft and to each other according to an embodiment.

FIG. 5 is a plan view of a shaft according to an embodiment.

### DETAILED DESCRIPTION

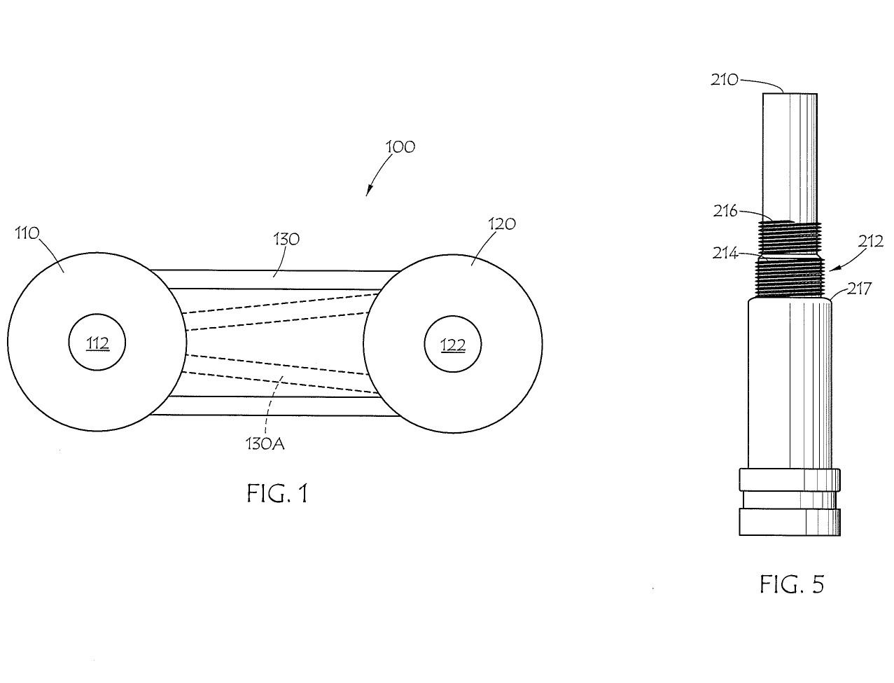

FIG. 1 shows a plan view of a CVT system 100. System 100 may include a primary drive pulley 110, a secondary driven pulley 120, and a belt 130. Each of primary drive pulley 110 and secondary driven pulley 120 may include a fixed or stationary sheave (not shown) and a moveable sheave (not shown). The moveable sheave may be moved with respect to the stationary sheave to allow belt 130 to move within the pulleys 110, 120. This may change the distance of belt 130 with respect to the drive 112 and driven shafts 122, thereby changing an effective gear ratio, which in turn changes the speed of driven shaft. Typically drive shaft 112 is coupled to the shaft of a motor, and runs at a generally constant speed, once the motor ramps up to speed.

Primary drive pulley 110 may be mounted and/or generally coupled to drive shaft 112. Similarly, a secondary driven pulley 120 may be coupled to a driven shaft 122. This may be accomplished via many known methods and systems. Any method or system of coupling capable of being used for this purpose may be used. This disclosure is not limited by the method or system of coupling of the pulleys to the respective shafts.

As shown, if the moveable sheave of the primary drive pulley 110 is moved away from the stationary sheave, belt 130A would ride further down in primary drive pulley 110. This would cause the speed of driven shaft 122 to generally decrease. If the moveable sheave of secondary driven pulley 122 is moved away from the stationary sheave, this would cause the belt 130A to ride lower in the driven pulley 120, which would cause the rotational speed of driven shaft 122 to generally increase (if the primary drive shaft 112 speed was held constant). In this manner, the ratio of speed of the relatively constant rotational speed of the drive shaft 112 and the driven shaft 122 can be constantly varied and controlled.

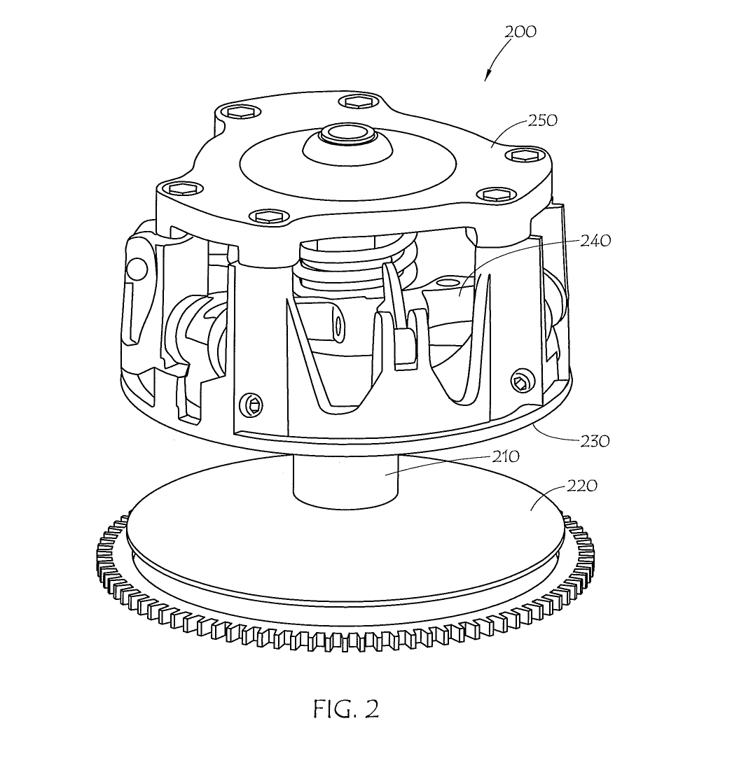

FIG. 2 shows a primary drive clutch system 200 according to an embodiment. System 200 may include a stationary sheave 220, a moveable sheave 230, a shaft 210, a spider portion 240, and a housing 250. Moveable sheave 230 may be moved with respect to stationary sheave 220, which causes belt (not shown) to move toward and away from shaft 210. This would cause the ratio of rotational speed of the shaft 210 to driven shaft (not shown) to change, and thereby change the speed of the vehicle this system 200 is a part of.

System 200 may include shaft 210. In an embodiment, shaft 210 may be coupled to the drive shaft of a vehicle or the shaft of the drive motor of the vehicle. Housing 250 may rotate directly or indirectly with shaft 210.

As explained above, moveable sheave 230 may be biased away from stationary sheave 220, and as shaft rotates, the configuration of weights (not shown) and housing 250 may cause moveable sheave 230 to move closer to stationary sheave 220. This may change the diameter at which a belt will ride between the sheaves, which will change the characteristics of the clutch system 200.

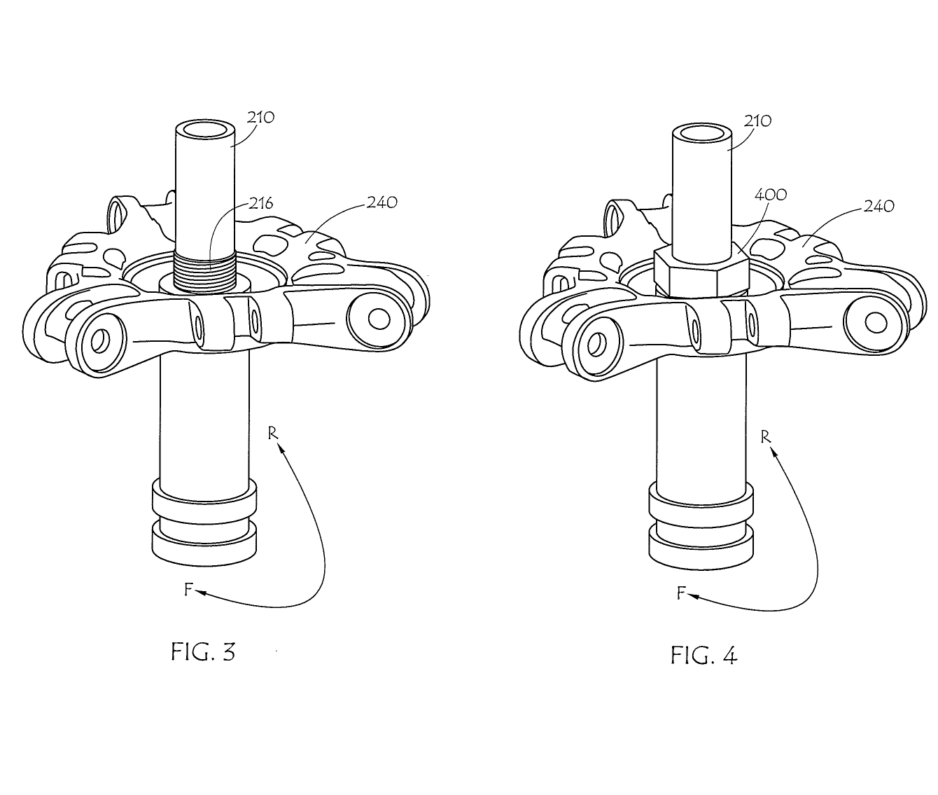

FIG. 3 shows an embodiment of a portion of system 200, which may include a spider portion 240. Spider portion 240 may be coupled to housing 250 and considered a separate portion of the system. Spider portion 240 may be coupled to shaft 210 and to housing 250. This configuration would facilitate spider portion 240 and housing 250 generally rotating with shaft 210. Furthermore, spider portion may slide up and down the housing towers, because the housing may be part of, or coupled to, moveable sheave 220.

In an embodiment, spider portion 240 may be coupled to shaft via portion 214. That is spider portion 240 and shaft 210 are threaded to couple to each other in a generally threadingly-type and/or turning type coupling. It will be appreciated that other coupling structures, methods, and/or substances may be used to couple spider 240 to shaft 210.

When shaft 210 rotates in a generally forward direction F, spider portion 240 may generally tend to tighten with respect to shaft 210. When shaft 210 rotates in a generally reverse direction R, spider portion 240 may generally tend to loosen, and/or unthread with respect to shaft 210. Furthermore, when shaft 210 accelerates or decelerates the mass and momentum of spider 240 and/or housing 250 may cause the spider 240 to generally uncouple from shaft 210. This may be a problem when the shaft 210 must rotate bidirectionally for forward and reverse of the vehicle (not shown) or if the shaft accelerates in the reverse direction, or during acceleration or deceleration of shaft 210.

FIG. 4 illustrates a portion of a system, according to an embodiment. This Figure shows the addition of a securing member 400. As described above, spider 240 may be coupled to shaft 210. Securing member 400 may also be coupled to shaft 210, and further coupled to the spider 240.

Shaft 210 may further include reverse threads 216 (compared to the spider threads), which may be configured to threadingly mate with threads of securing member 400. With this configuration, when shaft rotates generally in the reverse direction R, securing member 400 may generally tend to tighten to the face of the spider 240. Further, when shaft rotates in the reverse direction R, Spider 240 which would otherwise tend to loosen from the shaft will be prevented from loosening by the locking device which would tend to tighten. This configuration inhibits spider 240 and housing 250 from loosening or unthreading from shaft 210 when shaft 210 is rotating or accelerating in the reverse direction R.

When shaft 210 rotates generally in the forward direction, as described above, spider may generally tighten with respect to shaft 210. With this situation, securing member 400 may not be needed to inhibit the general unthreading of spider 240 with respect to shaft 210.

This configuration may enhance the coupling of spider 240 and system 200 to shaft 210 regardless of direction of rotation, while keeping the attachment location and other portions of the system easily adjustable, serviceable, and separable.

In some embodiments, spiders may be generally locked in position with respect to shaft 210 in service, regardless of direction of rotation. In this embodiment, when the shaft rotates in the forward direction, the spider will tend to generally tighten with respect to the shaft. When the shaft rotates generally in the reverse direction, the spider may tend to unthread or loosen from the shaft towards the securing member. The securing member will tend to move toward the spider and inhibit the unthreading to the spider with respect to the shaft.

In embodiments, spiders may need to have the location on the shaft to be moveable and fine-tuned. Once the spider is located, it may need to be locked in place. This configuration enhanced this fine tuning of the spider.

FIG. 5 shows a plan view of a shaft 210, according to an embodiment. Shaft 210 may include a corresponding locking structure 212. Corresponding locking structure 212 may include spider locking portion 214 and securing portion locking portion 216.

The spider 240 bears upon a shoulder 217 on shaft 210 as it is secured to the shaft with securing member 400.

In an embodiment, spider locking portion 214 may be generally forward threads on shaft 210. In this embodiment, spider 240 may have corresponding threads such that shaft 210 will generally threadingly couple to spider 240.

In an embodiment, securing portion locking portion 216 may be generally reverse threads on shaft 210. In this embodiment, securing portion 400 may have corresponding threads such that shaft 210 will generally threadingly couple to securing portion 400.

It will be appreciated that any suitable securing and/or inhibiting system, method, configuration, and/or substance may be used for this purpose for any portion of the system, without straying from the teachings of this disclosure.

Furthermore, this system and method of the securing member 400, and corresponding securing and/or locking configuration may be used to secure stationary sheave 220 to shaft 210, either in the primary drive CVT clutch or a secondary driven CVT clutch. This is not explicitly shown in the drawings, but one skilled in the art should know how to accomplish this. In some configurations, stationary sheave 220 may be overmolded or formed integrally with shaft 210. This configuration may save money, complexity, and/or manufacturing time.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. The disclosure disclosed herein may suitably be practiced in the absence of any element that is not specifically disclosed herein.

We claim:

1. A primary drive clutch system for a continuously variable transmission, the primary drive clutch system coupled to a drive shaft that is capable of bidirectional rotation comprising:
a stationary sheave (220) coupled to the drive shaft (210);
a movable sheave (230), housing (250) and spider portion (240) coupled to the drive shaft, the movable sheave being movable closer to or further from the stationary sheave along the drive shaft; and
a securing member (400) coupled to the drive shaft capable of preventing movement of said spider relative to the drive shaft.

2. The primary drive clutch system of claim 1, wherein the shaft has a corresponding locking structure (212) configured to couple to said securing member.

3. The primary drive clutch system of claim 2, wherein said corresponding locking structure comprises threading (214) for coupling the spider portion to the drive shaft where forward rotation of the drive shaft will cause the securing member to tighten on the spider.

4. The primary drive clutch system of claim 2, wherein said corresponding locking structure is further configured to couple to said securing member.

5. The primary drive clutch system of claim 4, wherein said corresponding locking structure further comprises reverse threads which will cause tightening of the securing member when the drive shaft is rotated in a reverse direction.

6. The primary drive clutch system of claim 1, wherein said securing member comprises threads.

7. The primary drive clutch system of claim 6, wherein securing member comprises a threaded nut-type structure (400).

8. The primary drive clutch system of claim 1, wherein a securing member is used to couple said stationary sheave to said drive shaft.

9. A vehicle comprising a primary drive clutch system for a continuously variable transmission, the primary drive clutch system coupled to a drive shaft that is capable of rotation comprising:
a stationary sheave coupled adjacent the drive shaft;
a movable sheave, housing and spider portion coupled adjacent the drive shaft, the movable sheave being movable closer to or further from the stationary sheave along the drive shaft; and
a securing member coupled to the drive shaft capable of inhibiting movement of said spider relative to the drive shaft.

10. The vehicle of claim 9, wherein the drive shaft has a corresponding locking structure configured to couple to said securing member.

11. The vehicle of claim 10, wherein said corresponding locking structure comprises forward threading for coupling the spider portion to the drive shaft where forward rotation of the drive shaft will cause the spider to tighten on the drive shaft.

12. The vehicle of claim 10, wherein said corresponding locking structure further comprises reverse threads which will cause tightening of said securing member when the drive shaft is rotated in the reverse direction or is decelerated.

13. The vehicle of claim 9, wherein said securing member comprises threads.

14. The vehicle of claim 13, wherein said securing member comprises a threaded nut-type structure.

15. The vehicle of claim 9, wherein said stationary sheave is coupled to said drive shaft with another securing member.

16. A method for securing the coupling of a CVT to a shaft, comprising:
threading the shaft to couple to corresponding threads of a spider portion such that when the shaft rotates in a forward direction tightening of the spider portion with respect to a shaft shoulder occurs;
reverse threading a portion of the shaft to reverse threadingly couple a securing member to the shaft such that when the shaft rotates in a reverse direction or decelerates tightening of the securing member with respect to the spider portion occurs;
coupling the spider portion to the shaft; and
locking the position of said spider portion with respect to the shaft by said securing member.

17. The method of claim 16, wherein said securing member comprises a threaded nut-type configuration.

18. A vehicle comprising a primary drive clutch system for a continuously variable transmission, the primary drive clutch system coupled to a drive shaft that is capable of rotation or acceleration, comprising:
a stationary sheave coupled adjacent the drive shaft at least in part using a securing member coupled to the drive shaft capable of inhibiting movement of said stationary sheave to the drive shaft;
wherein the drive shaft has a corresponding locking structure configured to couple to said securing member,
wherein said corresponding locking structure comprises threading for coupling said stationary sheave to the drive shaft where forward rotation of the drive shaft will cause said stationary sheave to tighten on the drive shaft, and
wherein said corresponding locking structure further comprises reverse threads which will cause tightening of said securing member when the drive shaft is rotated in the reverse direction or is decelerated.
